(19) United States
(12) Patent Application Publication
(10) Pub. No.: US 2025/0001978 A1
(43) Pub. Date: Jan. 2, 2025

(54) Mechanical Windshield Wiper Blade Wear System

(71) Applicant: Illinois Tool Works Inc., Glenview, IL (US)

(72) Inventor: Martin William Rosas, Cypress, TX (US)

(21) Appl. No.: 18/615,198

(22) Filed: Mar. 25, 2024

Related U.S. Application Data
(60) Provisional application No. 63/523,749, filed on Jun. 28, 2023.

(51) Int. Cl. B60S 1/40; B60S 1/38

(52) U.S. Cl. CPC B60S 1/4016; B60S 2001/3844; B60S 2001/4022

(57) ABSTRACT

Described is a wiper blade for a windshield of a vehicle. The wiper blade having a frame structure, a squeegee, a window, and a blade-wear system. The squeegee is coupled to the frame structure and includes a wiping lip. A window is positioned in or on the frame structure. A visual indicator transitions between a first position and a second position. The visual indicator is visible through the window when in the second position. The blade-wear system can be include an advancement mechanism, a gear train, and an indication mechanism. The advancement mechanism advances the gear train a predetermined amount to allow the indication mechanism to be viewable.

### RELATED APPLICATION

The present application claims priority to U.S. Provisional Patent Application No. 63/523,749, filed Jun. 28, 2023, and entitled “Mechanical Windshield Wiper Blade Wear System” which is hereby incorporated by reference in its entirety.

### BACKGROUND

Windshield wipers are used to remove rain, snow, ice, washer fluid, water, and/or other debris from a vehicle's front or rear windshield. Almost all vehicles are equipped with one or more windshield wipers, including cars, trucks, buses, train locomotives, watercraft (e.g., those with a cabin) and even some aircraft. In many jurisdictions, windshield wipers are a legal requirement.

Vehicles use a variety of wiper blade types and configurations, but a common objective for all wiper blade types is that they conform to the surface and/or contour of the glass upon which they are mounted (whether a front or rear windshield) to effectively clear the windshield. Over time, the wiping surface of the wiper blade's squeegee that contacts the windshield (the wiping lip) begins to degrade due to mechanical wear. Such degradation results in less effective wiping, streaks, and the like.

Currently, there is no indicator for physical wear on wiper blades that is directly correlated to the mechanical wear of the wiping lip. Instead, existing wear indicators consider ultraviolet (UV) exposure rather the mechanical wear that the wiper blade experiences. While UV exposure is an indicator of wear, UV exposure cannot accurately account for wiper blades that are used frequently and yet have limited UV exposure. That is, during a given time frame, a wiper blade that is used very frequently would wear down faster than one used seldomly; however, the UV wear indicator would not be able to distinguish between such wiper blades if they are exposed to the same amount of UV.

Despite advancements to date, a need exists for a wiper blade and wiper blade system that is not dependent on UV exposure, but actual usage. For example, a wiper blade and wiper blade system configured to indicate the number of cycles performed by a wiper blade, which is indicative of mechanical wear and/or damage to the wiping lip of a wiper blade

### SUMMARY

The present disclosure relates generally to an improved wiper blade, substantially as illustrated by and described in connection with at least one of the figures, as set forth more completely in the claims. More specifically, the present disclosure relates to a wiper blade and wiper blade system that is not dependent on pre-determined milestones, but rather reflects a physical condition of critical performance element. More specifically, a wiper blade and wiper blade system configured to indicate the number of cycles performed by a wiper blade, which is indicative of mechanical wear and/or damage to the wiping lip of a wiper blade.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates an example vehicle having a windshield and a pair of wiper blades.

FIG. 1b illustrates an assembly view of an example connection point between the wiper blade and the wiper arm.

FIG. 1c illustrates an example connection point between the wiper blade and the wiper arm.

FIG. 2a illustrates a schematic representation of an example blade-wear system in accordance with an aspect of the present disclosure.

FIG. 2b illustrates a schematic representation of an example advancement mechanism in accordance with an aspect of the present disclosure.

FIG. 2c illustrates a schematic representation of an example indication mechanism in accordance with an aspect of the present disclosure.

FIGS. 3a through 3d illustrate schematic representations of an example visual indicators.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The terms “coupled,” “coupled to,” and “coupled with” as used herein, each mean a relationship between or among two or more devices, apparatuses, elements, functions, operations, processes, components,, systems, subsystems, and/or means, constituting any one or more of: (i) a connection, whether direct or through one or more other devices, apparatuses, files, elements, functions, operations, processes, components, systems, subsystems, or means; and/or (ii) a functional relationship in which the operation of any one or more devices, apparatuses, elements, functions, operations, processes, components, systems, subsystems, or means depends, in whole or in part, on the operation of any one or more others thereof.

Wiper blades vary in size and shape. In some cases, wiper blades can be the same shape, but will vary in size. While wiper blades are most often associated with automobiles (e.g., cars, trucks, etc.), they are likewise employed in numerous other vehicles, such as trains, watercraft, and aircraft. Therefore, the following disclosure should not be limited to wiper blades and wiper arms used in automobiles, but rather would be applicable to wiper blades and wiper arms used to remove a liquid from any surface.

The present disclosure relates to a wiper blade and wiper blade system configured to detect and/or indicate mechanical wear or damage to the wiping lip of a wiper blade in real-time or near real-time. In one example, a wiper blade comprises: a frame structure; a squeegee coupled to the frame structure, wherein the squeegee comprises a wiping lip; a window positioned in or on the frame structure; and a visual indicator configured to transition between a first position and a second position, wherein the visual indicator is visible through the window when in the second position. In some examples, the visual indicator is not visible through the window when in the first position. The wiper blade can comprises a blade-wear system having an advancement mechanism mechanically coupled to an indication mechanism via a gear train. The blade-wear system is configured to transition the visual indicator between the first position and the second position as a function of completed cycles of the wiper blade. The visual indicator includes indicia reflecting a physical condition of the wiping lip or a number of completed cycles of the wiper blade. The indicia comprises a color gradient, text, a symbol, etc.

In another example, a blade-wear system for a wiper blade having a wiping lip and a window comprises: a gear train, an advancement mechanism, and an indication mechanism. The advancement mechanism is configured to advance the gear train in response to movement of the wiper blade across a surface (e.g., a windshield). The indication mechanism coupled to the advancement mechanism via the gear train, wherein the indication mechanism is configured to indicate a number of completed cycles of the wiper blade via a visual indicator that is visible through the window.

In yet another example, a wiper blade comprises: a frame structure having a window; a squeegee coupled to the frame structure, wherein the squeegee comprises a wiping lip; an advancement mechanism configured to advance a gear train in response to movement of the wiper blade across a surface; and an indication mechanism coupled to the advancement mechanism via the gear train, wherein the indication mechanism is configured to indicate a number of completed cycles of the wiper blade via a visual indicator that is visible through the window, wherein the visual indicator is configured to transition between a first position and a second position, and wherein the visual indicator is visible through the window when in the second position.

In some examples, the advancement mechanism comprises at least one weight coupled to a pivot rod, wherein the pivot rod is configured to advance the gear train via a pawl and a ratchet gear. In some examples, the gear train can comprise, inter alia, a driving gear and a driven gear.

In some examples, the at least one weight is configured to return to a neutral position via at least one stabilizing spring.

In some examples, the visual indicator is configured to transition between a first position and a second position, wherein the visual indicator is visible through the window when in the second position.

In some examples, the trigger mechanism is configured to maintain the visual indicator in the first position until a predetermined number of completed cycles of the wiper blade has been reached.

In some examples, the visual indicator is configured to transition between a first position and a second position incrementally. For example, the visual indicator can comprise an indicia, wherein a first portion of the indicia is visible through the window before a predetermined number of completed cycles of the wiper blade has been reached and a second portion of the indicia is visible through the window after the predetermined number of completed cycles of the wiper blade has been reached. The first portion comprises a first color, symbol, or text and the second portion comprises a second color, symbol, or text that is different from the first color, symbol, or text. Additionally or alternatively, the indicia can comprise a color gradient.

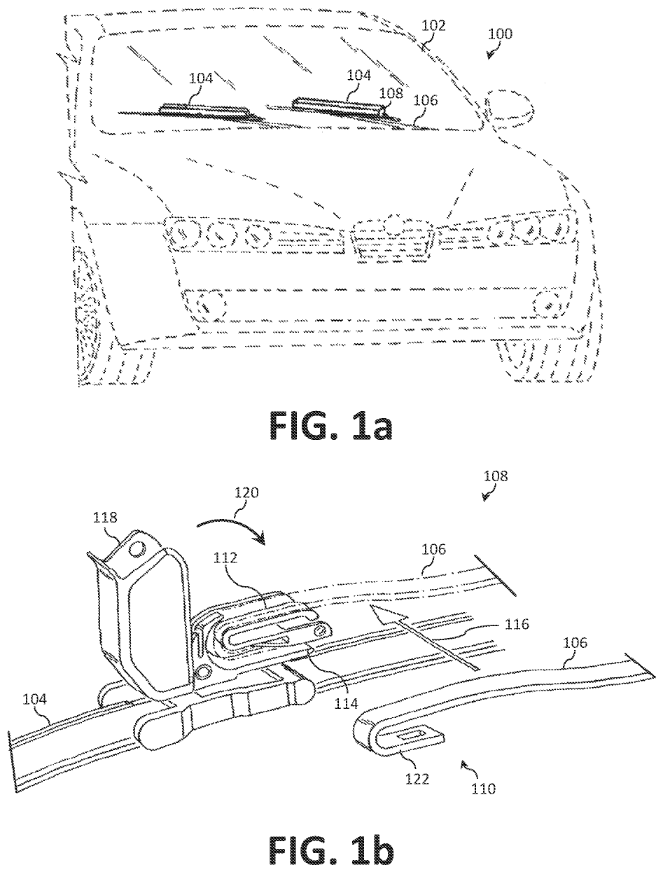

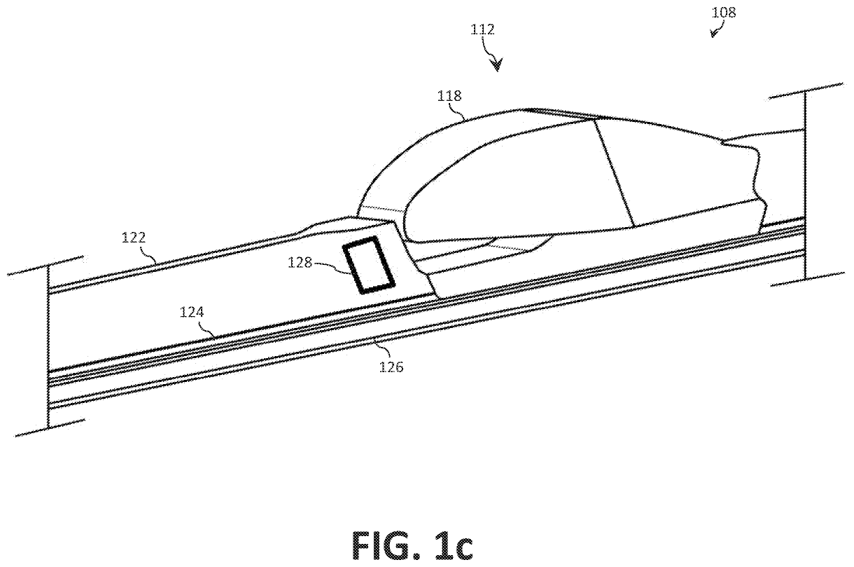

FIG. 1a illustrates an example vehicle 100 having a windshield 102 and a pair of wiper blades 104. As illustrated, each wiper blade 104 is removably coupled to a wiper arm 106 of the vehicle 100 via a coupling 108. As is known in the art, the wiper arms 106 (and, therefore, the wiper blades 104) are configured to translate back and forth across the windshield 102 to clear the windshield 102 of rain, snow, and debris via one or more electric motors and mechanical linkages associated with the vehicle 100.

FIG. 1b illustrates an assembly view of an example coupling 108 between the wiper blade 104 and the wiper arm 106. As illustrated, each wiper arm 106 includes or otherwise defines, at its distal end, an arm-side connector 110. The arm-side connector 110 is configured to engage and secure the wiper blade 104 via a complimentary blade-side connector 112 positioned on or otherwise associated with the wiper blade 104. In the illustrated example, the arm-side connector 110 is inserted into a J-shaped slot 114 of the blade-side connector 112 as indicated by arrow 116. Once assembled, a locking cap 118 can be folded as indicated by arrow 120 (e.g., pivoted about a hinge) and positioned to cover, secure, and protect the connected arm-side connector 110 and blade-side connector 112. In the illustrated example, the wiper arm 106 includes an arm-side connector 110 configured a J-Hook connector, but other connector types are contemplated.

The windshield wiper blade 104 and components thereof (e.g., the frame structure 122, the squeegee 124, and/or wiping lip 126) can be fabricated from one or more elastomeric materials. Example elastomeric materials include, for example, thermoplastic polyurethane (TPU), thermoplastic vulcanizates (TPV), thermoplastic elastomers (TPE), flexible polyurethane (FPU), silicon, etc. The frame structure 122 is configured to couple to the wiper arm 106 via the blade-side connector 112 of the coupling 108. The blade-side connector 112 may be integral with the frame structure 122 or attached thereto via one or more fasteners, adhesives, etc.

In some examples, two or more components of the windshield wiper blade 104 can be formed from the same material and/or as a single, integrated component. For example, the squeegee 124 and the wiping lip 126 could be fabricated as a single component. In some examples, the windshield wiper blade 104 (or a portion thereof) can be a printed plastic material component (e.g., thermoplastic, TPU, FPU, etc.). Printed plastic material components can be printed with great accuracy and with numerous details, which is particularly advantageous, for example, in creating components requiring complex and/or precise features. In addition, additive manufacturing techniques obviate the need for mold tooling, thereby lowering up-front manufacturing costs, which is particularly advantageous in low-volume productions. In some examples, the windshield wiper blade 104 may be fabricated using material extrusion (e.g., fused deposition modeling (FDM)), stereolithography (SLA), selective laser sintering (SLS), material jetting, binder jetting, powder bed fusion, directed energy deposition, VAT photopolymerisation, and/or any other suitable type of additive manufacturing/3D printing process.

In one example, the illustrated wiper blade 104 includes a frame structure 122, a squeegee 124 having a wiping lip 126, a window 128 (e.g., a viewing window) positioned in or on the frame structure 122, and a visual indicator 202. With reference to FIG. 1c, the wiper blade 104 can include one or more windows 128, which may be in the form of a transparent window. The one or more windows 128 can be positioned on the frame structure 122, the blade-side connector 112, or elsewhere on the wiper blade 104 such that the one or more windows 128 are visible to the operator of the vehicle 100 (e.g., through the windshield).

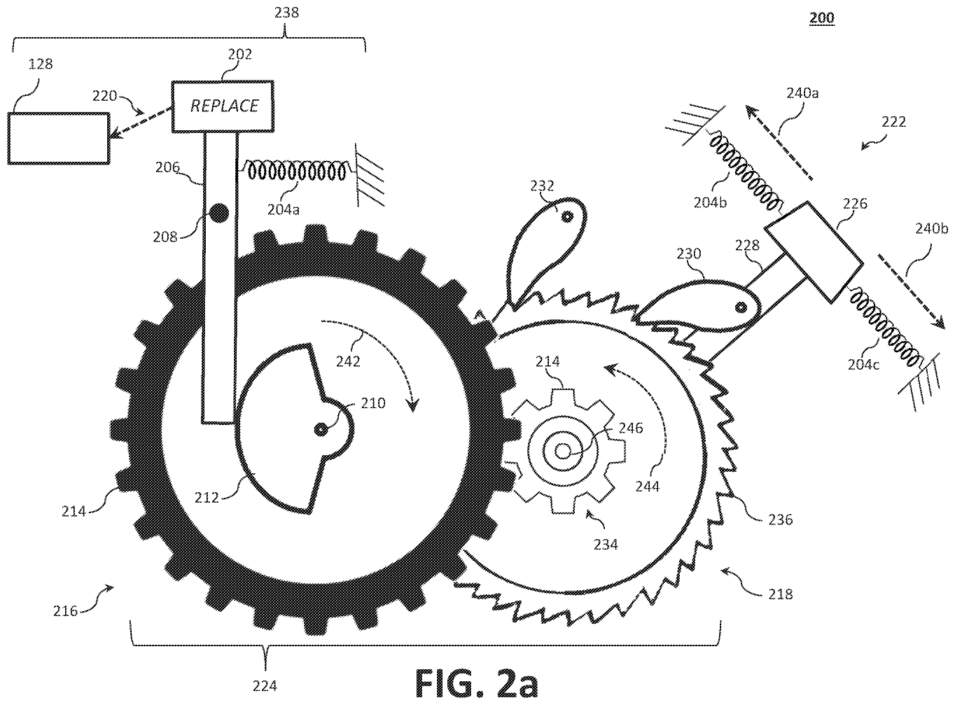

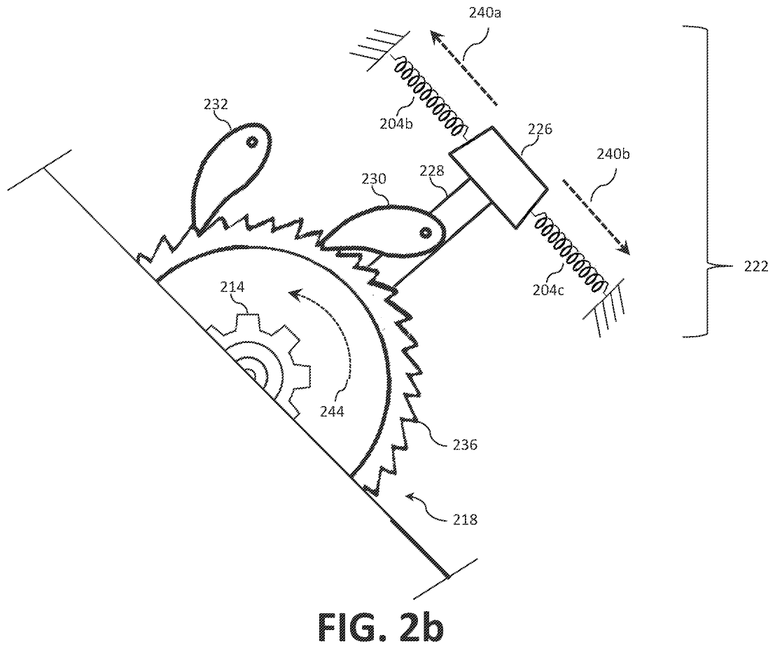

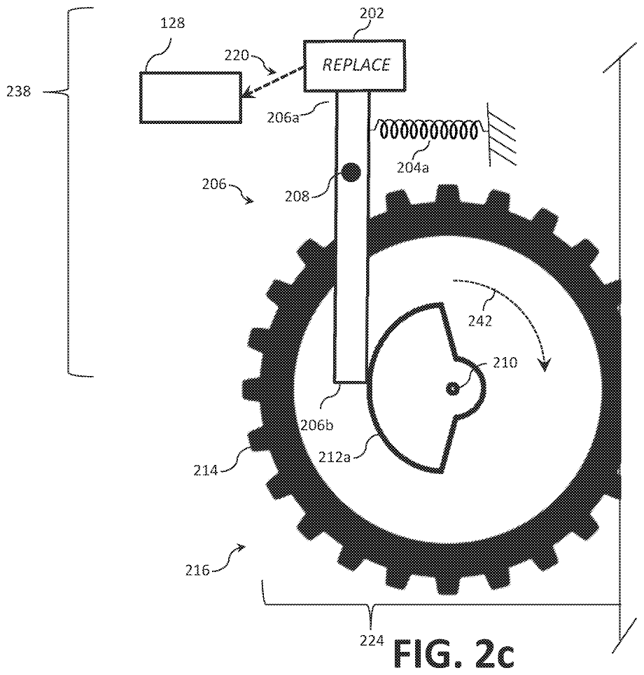

FIGS. 2a through 2c illustrate an example blade-wear system 200 and various components thereof in accordance with aspects of the present disclosure. Specifically, FIG. 2a illustrates a schematic representation of the example blade-wear system 200, while FIGS. 2b and 2c illustrate, respectively, schematic representations of an example advancement mechanism 222 and an example indication mechanism 238. As illustrated, the example blade-wear system 200 generally comprises an indication mechanism 238 mechanically coupled to an advancement mechanism 222 via a gear train 224. In operation, the advancement mechanism 222 serves to track the completed cycles of the wiper blade 104, while the indication mechanism 238 provides the visual indication to the operator that the wiper blade 104 has reached a predetermined number of cycles. The gear train 224 mechanically links the advancement mechanism 222 to the indication mechanism 238 at a predetermined gear ration. For example, the advancement mechanism 222 is configured to advance the gear train 224 in response to movement of the wiper blade 104 across a windshield 102 or other surface.

In operation, the blade-wear system 200 is configured to transition the visual indicator 202 between a first position and a second position as a function of completed cycles of the wiper blade 104. In some examples, the visual indicator 202 is not visible through the window 128 when in the first position and is visible through the window 128 when in the second position.

As best illustrated in FIG. 2b, the advancement mechanism 222 generally comprises a ratchet gear 218, one or more weights 226, a pivot rod 228, and a pawl 230. The advancement mechanism 222 outputs, via the ratchet gear 218, a rotational force as a function of the completed cycle of the wiper blade 104. To that end, the one or more weights 226 are aligned orthogonally to a direction of movement of the wiper blade 104. The one or more weights 226 may be, for example, fabricated from metal, plastic, stone, minerals, or a combination thereof. As illustrated, the weight 226 is coupled to a distal end of the pivot rod 228, which mechanically links the weight 226 to a pawl 230. In the illustrated example, the pivot rod 228 is generally linear, but other shapes are contemplated and different shapes can be employed depending on the position of the advancement mechanism 222 within the wiper blade 104.

In the illustrated example, the advancement mechanism 222 further comprises a first stabilizing spring 204b and a second stabilizing spring 204c. Therefore, in some examples, the weight 226 is coupled to a first stabilizing spring 204b and a second stabilizing spring 204c, one or both of which can be configured to return the weight 226 to a neutral position. That is, the first stabilizing spring 204b and the second stabilizing spring 204c are configured to return and/or maintain the weight 226 at a neutral position (e.g., a center position or an equilibrium position) after a completed cycle of the wiper blade 104 and/or when the wiper blade 104 is inactive. While stabilizing springs are illustrated, the spring action could instead be derived from the pivot arm material, through a flexing motion, thus obviating the need for a physical spring.

As the wiper blade 104 cycles back and forth across the surface (e.g., a windshield 102) to perform a completed cycle, the weight 226 will likewise travel back and forth as indicated by first arrow 240a and second arrow 240b. During operation, inertia of the weight 226 causes the pivot rod 228 and the pawl 230 to pivot back and forth about a pivot point. The pivot point can be, in some cases, coaxial with the axis of rotation 246 of the ratchet gear 218. The pawl 230 is configured to engage and advance the gear train 224 to output a rotational force via the ratchet gear 218 having a plurality of ratchet teeth 236. The pawl 230 mechanically engages the gear train 224 through its interaction with the ratchet teeth 236 of the ratchet gear 218. In some examples, a second pawl 232 may be provided to prevent the ratchet gear 218 from rotating in a directing that is counter to the axis of rotation 246 indicated by arrow 244 during period where the pawl 230 is momentarily disengaged.

The advancement mechanism 222 can be calibrated so that each advancement of the ratchet gear 218 represents a completed cycle of the wiper blade 104. In other words, each completed cycle of the wiper blade 104 cause the pawl 230 to increment the ratchet gear 218 about the axis or rotation 246 by a single ratchet tooth 236. As the wiper blade 104 travels in a first direction, the weight 226 swings in the direction indicated by arrow 240b (i.e., a first half cycle of the wiper blade 104), the pawl 230 slides or click back over a ratchet tooth 236; however, as the wiper blade 104 reverses directions to travel in a second direction opposite the first direction, the weight 226 swings in the direction indicated by arrow 240a (i.e., during a second half cycle of the wiper blade 104), the pawl 230 engages a ratchet tooth 236 and urges the ratchet tooth 236 such that ratchet gear 218 rotates about the axis of rotation 246 (as indicated by arrow 244).

The number of completed cycles of the wiper blade 104 needed to complete a full rotation of the ratchet gear 218 is a function of the number of ratchet teeth 236. For example, if the ratchet gear 218 has 100 ratchet teeth 236, 100 completed cycles of the wiper blade 104 will be necessary to complete a full rotation of the ratchet gear 218. Therefore, the number of ratchet teeth 236 employed can be selected on the expected lifespan of the wiper blade 104. Similarly, as will be discussed, the gear train 224 gearing can also be selected or adjusted based on the expected lifespan of the wiper blade 104.

The number of completed cycles of the wiper blade 104 needed to trigger the flag or complete rotations is dependent on the gear train 224 and ultimate gear ratio. Different wiper blade models may require a different target trigger cycle, but the number of completed cycles could be between one-hundred thousand cycles up to one million cycles. For example, if the indication mechanism 238 needs to be triggered after two-hundred thousand cycles, the gear train 224 with a gear ratio of 200,000:1. To achieve this gear ratio, the gear train may be designed with multiple gears of varying number of teeth. Further, planetary gears may be employed due to space constraints. The use of indicia may also affect the gear ratio depending on the indication mechanism 238.

The indication mechanism 238 generally comprises a trigger mechanism 212, a support arm 206, a spring 204a, and a visual indicator 202. The indication mechanism 238 is drivingly coupled to and driven by the advancement mechanism 222. That is, the indication mechanism 238 is configured to receive the rotational force from the advancement mechanism 222 via the gear train 224. As will be discussed, the speed (e.g., rotations per minute (RPM)) and/or torque of the rotational force, however, can be regulated as desired via the gear train 224.

The illustrated visual indicator 202 is coupled to a distal end 206a of the support arm 206. In the illustrated example, the support arm 206 is generally linear, but other shapes are contemplated and different shapes can be employed depending on the position of the indication mechanism 238 within the wiper blade 104. The visual indicator 202 includes indicia reflecting a physical condition of the wiping lip 126 or a number of completed cycles of the wiper blade 104. The visual indicator 202 can be, for example, a passive indicator, such as a flag or other component with indicia formed, positioned, or printed thereon. In other examples, the visual indicator 202 can be, for example, an active indicator, such as a light emitting diode (LED), liquid crystal display (LCD) display, etc., which can be activated by the trigger mechanism 212.

The support arm 206 is configured to pivot about a pivot axis 208 (e.g., a support pin) such that the visual indicator 202 transitions between a first position and a second position. In the first position, the visual indicator 202 is not aligned with the window 128 whereas, in the second position, the visual indicator 202 is aligned with the window 128 and therefore visible therethrough. In the illustrated example, the indicia includes the word “Replace,” which would be visible through the window 128 when the support arm 206 and visual indicator 202 assume the second position. The proximal end 206b of the support arm 206 engages the trigger mechanism 212. For example, the trigger mechanism 212 can be configured as a cam having a lobe portion 212a. In another example, the cam could be replaced with a gear having a non-engaging section. For example, the trigger gear would be complete, while the driver gear would have a missing section of teeth. In this example, the trigger gear would only be engaged once the drive gear is rotated to an engagement position.

The trigger mechanism 212 is configured to maintain the visual indicator 202 in the first position until a predetermined number of completed cycles of the wiper blade 104 has been reached, at which point the visual indicator 202 is release and permitted to assume the second position (e.g., via a spring 204a), whether directly or incrementally. The shape of trigger mechanism 212 can be adjusted to provide a desired transition profile of the visual indicator 202 as it transitions between the first position and the second position. In one example, the visual indicator 202 is positioned out from under the window 128 when in the first position and, once the trigger mechanism 212 reaches a predetermined position (e.g., as it rotates about its axis of rotation 210), the support arm 206 pivots such that it and the visual indicator 202 assume the second position via the spring 204a. As a result, the visual indicator 202 is urged along a predetermined path 220 to be viewed in the window 128. For example, as illustrated, when in the first position, the lobe portion 212a of the trigger mechanism 212 pushes the proximal end 206b of the support arm 206 to counter the force imparted by the spring 204a. As the trigger mechanism 212 rotates about the axis of rotation 210, the lobe portion 212a rotates and clears the proximal end 206b of the support arm 206, thus allowing the force imparted by the spring 204a to pivot the support arm 206 about pivot axis 208 such that the distal end 206a of the support arm 206 and the visual indicator 202 move as indicated by arrow 220 to assume the second position.

In the illustrated example, the trigger mechanism 212 and the support arm 206, in effect, provide a binary output in that the visual indicator 202 is either in the first position or the second position based on the position of the trigger mechanism 212; however, in some examples, the transition can be incremental such that the visual indicator 202 can assume one or more intermediate positions between the first position and the second position. For example, the trigger mechanism 212 can be configured and/or shaped such that the support arm 206 and visual indicator 202 transitions from the first position to the second position incrementally (e.g., gradually). In one example, rather than a lobe portion 212a with a ledge, the lobe portion may instead include a gradual ramp or slow such that the visual indicator 202 gradually transitions from the first position to the second position. A gradual transition can be beneficial as it provides an earlier indication that the wiper blade 104 will require replacement, thus enabled the operator to purchase replacement parts. In this example, the visual indicator 202 can include indicia where first portion of the indicia is visible through the window 128 before a predetermined number of completed cycles of the wiper blade 104 has been reached and a second portion of the indicia is visible through the window 128 after the predetermined number of completed cycles of the wiper blade 104 has been reached. For example, the first portion may include a first color, symbol, or text, while the second portion may include a second color, symbol, or text that is different from the first color, symbol, or text.

The illustrated gear train 224 includes a driving gear 234 and driven gear 216. The driving gear 234 is mechanically coupled to the advancement mechanism 222 and configured to receive the rotational force from the advancement mechanism 222 at the driving gear 234. In the illustrated example, the driving gear 234 and the driven gear 216 mechanically engaged one another at a fixed gear ratio via one or more gear teeth 214.

In the illustrated example, the driving gear 234 and the ratchet gear 218 are coaxial and rotationally fixed relative to one another (e.g., via a support pin). In some examples, the driving gear 234 and the ratchet gear 218 can be fabricated as a single component. The driving gear 234 and ratchet gear 218 are, in response to the rotational force from the advancement mechanism 222, configured to rotate together about the axis of rotation 246 as indicated by arrow 244.

The driven gear 216 (illustrated here as the terminating gear) and trigger mechanism 212 are coaxial and rotationally fixed relative to one another (e.g., via a support pin). In some examples, the driven gear 216 and the trigger mechanism 212 can be fabricated as a single component. The driven gear 216 and trigger mechanism 212 are, in response to the rotational force from the driving gear 234 (weather directly or indirectly), configured to rotate together about the axis of rotation 210 as indicated by arrow 242.

A person of skill in the art would understand that the gear train 224 can be configured to rotate in any desired direction and at any desired gear ratio. More specifically, the driving gear 234 is coupled to the driven gear 216 via their respective teeth 214. As the ratchet gear 218 is advanced by the advancement mechanism 222, the driving gear 234 advances the driven gear 216 and, therefore, the trigger mechanism 212 about the axis of rotation 210 as indicated by arrow 242. Once the trigger mechanism 212 has rotated a predetermined number of completed cycles of the wiper blade 104, the indication mechanism 238 will trigger the support arm 206 and the visual indicator 202.

As can be appreciated, the gear ratio is the ratio of the number of rotations of a driving gear 234 to the number of rotations of a driven gear 216. For example, the gear train 224 may employ a gear ratio that correlates to a predetermined number of wipe cycles for a given wiper blade 104, which may be based on optimal wiper blade performance. A person having skill in the art would understand that the gear ratio between the driving gear 234 and the driven gear 216 is a function of the number of gear teeth 214 provided on each of the driving gear 234 and the driven gear 216. The gear ratio can be selected to achieve a desired number of completed cycles of the wiper blade 104.

While the gear train 224 is illustrated with two gears (i.e., the driving gear 234 and the driven gear 216), one more additional gears (e.g., intermediate gears) may be provided between the driving gear 234 and the driven gear 216 to adjust, for example, the gear ratio between the driving gear 234 and the driven gear 216, speed, torque, etc. Therefore, a person having skill in the art would understand that the gear train 224 could be made up of a multitude of gears i.e. 2, 3, 4, 5 gears etc.

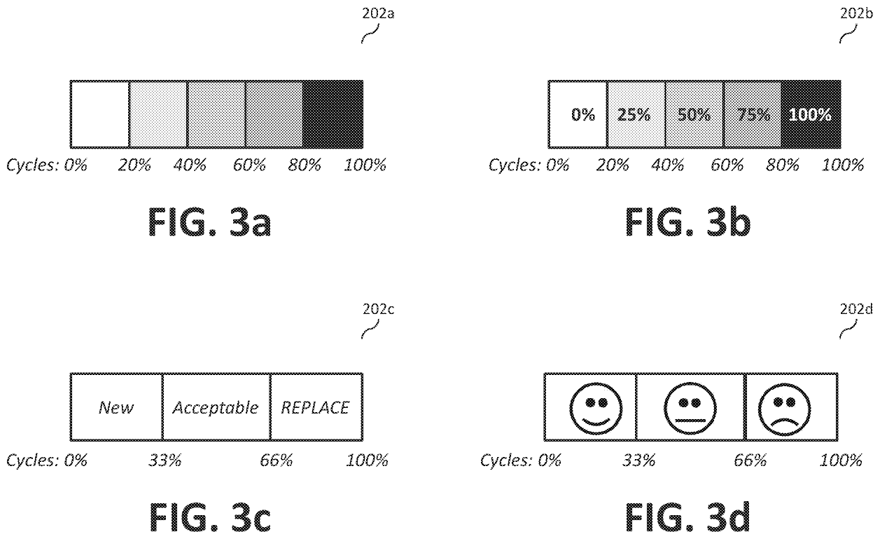

While the indicia is illustrated as the word “REPLACE,” a person of skill in the art would, therefore, understand that the indicia could include colors, words, symbols, gradients (whether greyscale colors, RGB colors, bars, or the like), etc. In one example, the indicia can be a color gradient (e.g., green to yellow to red) that gradually transitions as the visual indicator transitions from the first position to the second position. Example visual indicators 202 are illustrated in FIGS. 3a through 3d. In the illustrated examples, as the completed cycle count increases from newly installed or reset (0%) to a predetermined number of completed cycles of the wiper blade 104 (100%).

FIG. 3a illustrates a visual indicator 202a having a color-gradient indicia to indicate the remaining lifespan of the wiper blade 104 (e.g., based on completed cycles). The portion of the visual indicator 202a visible through the window 128 increments from a first color (illustrated as white) to a second color (illustrated as black) via one or more transitional colors therebetween, such as a color gradient. While the visual indicator 202a is illustrated as white, black, and various shades of greyscale, full color can be used (e.g., RGB color values). For example, the first color may be green while the second color may be red, where the one or more transitional colors therebetween includes yellow-green, yellow, orange, etc.

FIG. 3b illustrates a visual indicator 202b having a numerical indicia to indicate the remaining lifespan of the wiper blade 104. The portion of the visual indicator 202b visible through the window 128 increments from a first number (illustrated as 0%) to a second number (illustrated as 100%) via one or more transitional numbers therebetween (illustrated as 25%, 50%, 75%). In the illustrated example, the visual indicator 202b may further include a background color, such as the color gradient discussed in connection with FIG. 3a.

FIG. 3c illustrates a visual indicator 202c having a textual indicia to indicate the remaining lifespan of the wiper blade 104. The portion of the visual indicator 202c visible through the window 128 increments from a first text (illustrated as the word “New”) to a second text (illustrated as the word “REPLACE”) via one or more transitional forms of text therebetween (illustrated as the word “Acceptable”). In the illustrated example, the visual indicator 202c may further include a background color, such as the color gradient discussed in connection with FIG. 3a.

FIG. 3d illustrates a visual indicator 202d having a symbol-based indicia to indicate the remaining lifespan of the wiper blade 104. The portion of the visual indicator 202d visible through the window 128 increments from a first symbol (illustrated as a smiley face) to a second symbol (illustrated as a frown face) via one or more transitional symbols therebetween (illustrated as an indifferent face). In the illustrated example, the visual indicator 202d may further include a background color, such as the color gradient discussed in connection with FIG. 3a.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A wiper blade comprising:
a frame structure;
a squeegee coupled to the frame structure, wherein the squeegee comprises a wiping lip;
a window positioned in or on the frame structure; and
a visual indicator configured to transition between a first position and a second position, wherein the visual indicator is visible through the window when in the second position.

2. The wiper blade of claim 1, wherein the visual indicator is not visible through the window when in the first position.

3. The wiper blade of claim 1, further comprising a blade-wear system having an advancement mechanism mechanically coupled to an indication mechanism via a gear train, wherein the blade-wear system configured to transition the visual indicator between the first position and the second position as a function of completed cycles of the wiper blade.

4. The wiper blade of claim 1, wherein the visual indicator includes indicia reflecting a physical condition of the wiping lip or a number of completed cycles of the wiper blade.

5. The wiper blade of claim 4, wherein the indicia comprises a color gradient.

6. The wiper blade of claim 4, wherein the indicia comprises a symbol.

7. A blade-wear system for a wiper blade having a wiping lip and a window, the blade-wear system comprising:
a gear train;
an advancement mechanism configured to advance the gear train in response to movement of the wiper blade across a surface; and
an indication mechanism coupled to the advancement mechanism via the gear train, wherein the indication mechanism is configured to indicate a number of completed cycles of the wiper blade via a visual indicator that is visible through the window.

8. The blade-wear system of claim 7, wherein the advancement mechanism comprises at least one weight coupled to a pivot rod, wherein the pivot rod is configured to advance the gear train via a pawl and a ratchet gear.

9. The blade-wear system of claim 8, wherein the at least one weight is configured to return to a neutral position via at least one stabilizing spring.

10. The blade-wear system of claim 7, wherein the gear train comprises a driving gear and a driven gear.

11. The blade-wear system of claim 7, wherein the visual indicator is configured to transition between a first position and a second position, wherein the visual indicator is visible through the window when in the second position.

12. The blade-wear system of claim 11, wherein a trigger mechanism is configured to maintain the visual indicator in the first position until a predetermined number of completed cycles of the wiper blade has been reached.

13. The blade-wear system of claim 7, wherein the visual indicator is configured to transition between a first position and a second position incrementally.

14. The blade-wear system of claim 13, wherein the visual indicator comprises an indicia, wherein a first portion of the indicia is visible through the window before a predetermined number of completed cycles of the wiper blade has been reached and a second portion of the indicia is visible through the window after the predetermined number of completed cycles of the wiper blade has been reached.

15. The wiper blade of claim 14, wherein the first portion comprises a first color, symbol, or text and the second portion comprises a second color, symbol, or text that is different from the first color, symbol, or text.

16. The wiper blade of claim 14, wherein the indicia comprises a color gradient.

17. A wiper blade comprising:
a frame structure having a window;
a squeegee coupled to the frame structure, wherein the squeegee comprises a wiping lip:
an advancement mechanism configured to advance a gear train in response to movement of the wiper blade across a surface; and
an indication mechanism coupled to the advancement mechanism via the gear train, wherein the indication mechanism is configured to indicate a number of completed cycles of the wiper blade via a visual indicator that is visible through the window,
wherein the visual indicator is configured to transition between a first position and a second position, and
wherein the visual indicator is visible through the window when in the second position.

18. The wiper blade of claim 17, wherein the visual indicator comprises an indicia, wherein a first portion of the indicia is visible through the window before a predetermined number of completed cycles of the wiper blade has been reached and a second portion of the indicia is visible through the window after the predetermined number of completed cycles of the wiper blade has been reached.

19. The wiper blade of claim 17, wherein the advancement mechanism comprises at least one weight coupled to a pivot rod, wherein the pivot rod is configured to advance the gear train via a pawl and a ratchet gear.

20. The wiper blade of claim 17, wherein the visual indicator is configured to transition between a first position and a second position incrementally.
